(19) United States
(12) Patent Application Publication
(10) Pub. No.: US 2015/0161549 A1
(43) Pub. Date: Jun. 11, 2015

(54) PREDICTING OUTCOMES OF A MODELED SYSTEM USING DYNAMIC FEATURES ADJUSTMENT

(71) Applicant: Adobe Systems Incorporated, San Jose, CA (US)

(72) Inventor: Kourosh Modarresi, Stanford, CA (US)

(73) Assignee: Adobe Systems Incorporated, San Jose, CA (US)

(21) Appl. No.: 14/097,998

(22) Filed: Dec. 5, 2013

(51) Int. Cl. G06Q 10/06

(52) U.S. Cl. CPC G06Q 10/06375; G06Q 10/067; G06Q 10/0639

(57) ABSTRACT

Techniques are disclosed for predicting outcomes of a system modeled on analytical data related to website-related metrics by dynamically adjusting one or more input or output variables. A regularized singular value decomposition technique can be used to estimate missing data. The completed data set can be used to model the performance of the website and to predict various outcomes by changing one or more of the input or output variables. The effect of varying one or more input variables on an output variable can be computed using regression analysis and/or a Random Forests® framework to estimate the relationships between the variables in the model. The effect of specific changes to one or more input variables on one or more output variables can be computed. The amount of change to an input variable needed to achieve a specific change in an output variable can be computed using regression analysis.

### FIELD OF THE DISCLOSURE

This disclosure relates to the field of data processing, and more particularly, to techniques for predicting outcomes of a modeled system by dynamically adjusting one or more input or output variables.

### BACKGROUND

Websites are often used as channels of commerce. As such, businesses have an interest in maximizing revenue and profit generated through such websites. Users of these websites often access and interact with media and content in a variety of ways. When users visit a website, it is possible to track and record their activities to analytically determine what portions of a website are being accessed and what media and content are resulting in value to the owner of the website. Tracking and maintaining up-to-date information regarding user activity and the value derived from different components of the website is one aspect of maintaining the website to extract maximum returns.

### BRIEF DESCRIPTION OF THE DRAWINGS

The accompanying drawings are not intended to be drawn to scale. In the drawings, each identical or nearly identical component that is illustrated in various figures is represented by a like numeral.

FIG. 1 illustrates an example client-server computing architecture configured in accordance with an embodiment of the present invention.

FIG. 2 is a block diagram representing an example computing device that can be used in conjunction with an embodiment of the present invention.

FIG. 3 illustrates an example methodology for predicting outcomes of a modeled system, in accordance with an embodiment of the present invention.

FIG. 4 depicts an example methodology for computing missing values in a data set, in accordance with an embodiment of the present invention.

### DETAILED DESCRIPTION

As mentioned above, user activity at a website can be tracked and analyzed. Tools exist for collecting and presenting such analytical data. These tools may be used to correlate various features in the analytics, such as revenue generated per user per website visit, with user behavior. For example, sales figures may be correlated to the length of an individual user visit to a website, where the data may indicate that the number of items purchased increases with the length of the visit. In such a case, empirically one may assume that sales can be increased by incentivizing users to extend the length of their visits to the website. However, as will be appreciated in light of this disclosure, often such assessments are complicated by the effect of several interrelated variables, some of which may be unknown or unpredictable. In particular, present solutions do not provide tools for determining outcomes resulting from predictable and unpredictable future user behavior or changes in other input variables based on analytical data collected on prior user behavior. Further, present solutions do not provide tools for using analytical data to quantify which user behaviors or other input variables lead to desired outcomes.

To this end, and in accordance with an embodiment of the present invention, techniques are provided for predicting outcomes of a system modeled on analytical data by dynamically adjusting one or more input or output variables. In one specific embodiment, a computing device is configured to receive analytical data related to website-related metrics, or features. Such data may include several variables, for example, sales revenue per user derived via the website, number of visits to the website per user, length in time of each visit per user, number of unique visits per user, number of items ordered per user, and number of unique orders per user, among other information. If any data is missing or unavailable, the device is configured to estimate some or all of the missing data using regularized singular value decomposition of the available data. The performance of the website with respect to any of the variables can be modeled using the completed data set. This model can be used to determine which variables, when changed, have the greatest effect on one or more other variables. This model can also be used by the device to predict various outcomes that result when one or more of the variables are changed and/or to determine which changes result in certain desired outcomes. Numerous configurations and variations will be apparent in light of this disclosure.

As will be further appreciated in light of this disclosure, when making certain business decisions, it can be desirable to assess the effects of predictable and unpredictable events to a system, such as changes in customer behaviors at a website. For example, it may be desirable to assess the effect of changes to input variables on an output variable. In another example, it may be desirable to determine which input variables have the greatest effect on an output variable. In yet another example, it may be desirable to ascertain the value(s) of one or more input variables that result in a targeted output variable. In accordance with various embodiments, such assessments can be achieved using multiple linear regression analysis, time series analysis, and ensemble learning methods.

In more detail and in accordance with an embodiment, the relationships between the variables in a model derived from analytical data can be estimated by computing the impact or effect of varying one or more so-called input variables on one or more so-called output variables using regression analysis and/or a decision tree learning framework, such as Random Forests®. The impact may be measured, for example, as the relative magnitude of change in each output variable for a given magnitude of change in a given input variable or set of input variables. The impact analysis may, for instance, be useful for determining which variable or combination of variables, when changed, affect the greatest magnitude of change in other variables. For example, the impact analysis may reveal that increasing the number of items ordered by a user during a particular visit to the website and increasing the average number of unique visits to the website each have greater impacts on sales revenue than increasing or otherwise changing any other variables.

In accordance with another embodiment, the effect of specific changes to one or more input variables on one or more output variables can be computed using the model. In this scenario, regression analysis can be used to predict the effect on a particular output when one or more inputs are changed by a specific amount. For example, the effect analysis may reveal that increasing the average number of orders per website visit by 20% will result in a 9.4% increase in the average sales revenue per website visit. In yet another embodiment, the amount of change to an input variable needed to achieve a specific change in an output variable can be determined using the model, also using regression analysis. For example, the effect analysis may reveal that to achieve a 20% increase in average sales revenue per website visit, the average number of unique website visits should be decreased by 8%.

In accordance with another embodiment, linear multiple regression can be implemented in a computing device to determine which input variables have the most significant effect on an output variable. The regression analysis produces a set of coefficients for each input variable. Each coefficient represents a relative magnitude that when compared (e.g., in absolute terms) to the other coefficients provides the relative effect of changes made to the corresponding input variable on the output variable. Additionally or alternatively, an ensemble learning technique, such as at least 1,000 binary decision trees in a Random Forests® model, can be implemented in the computing device to compute the most significant input variables; that is, the input variables that have the most significant effect on an output variable. Given a set of constraints (e.g., taken from the physics of a specific data set), a random subset of the most significant input variables can be used to compute different options for obtaining a target output variable value. Such options include different combinations of input variables within the subset and different values for those input variables. In some embodiments, one or more of the above techniques can be implemented in the computing device using instructions coded in the R and/or Revolution R programming languages.

System Architecture

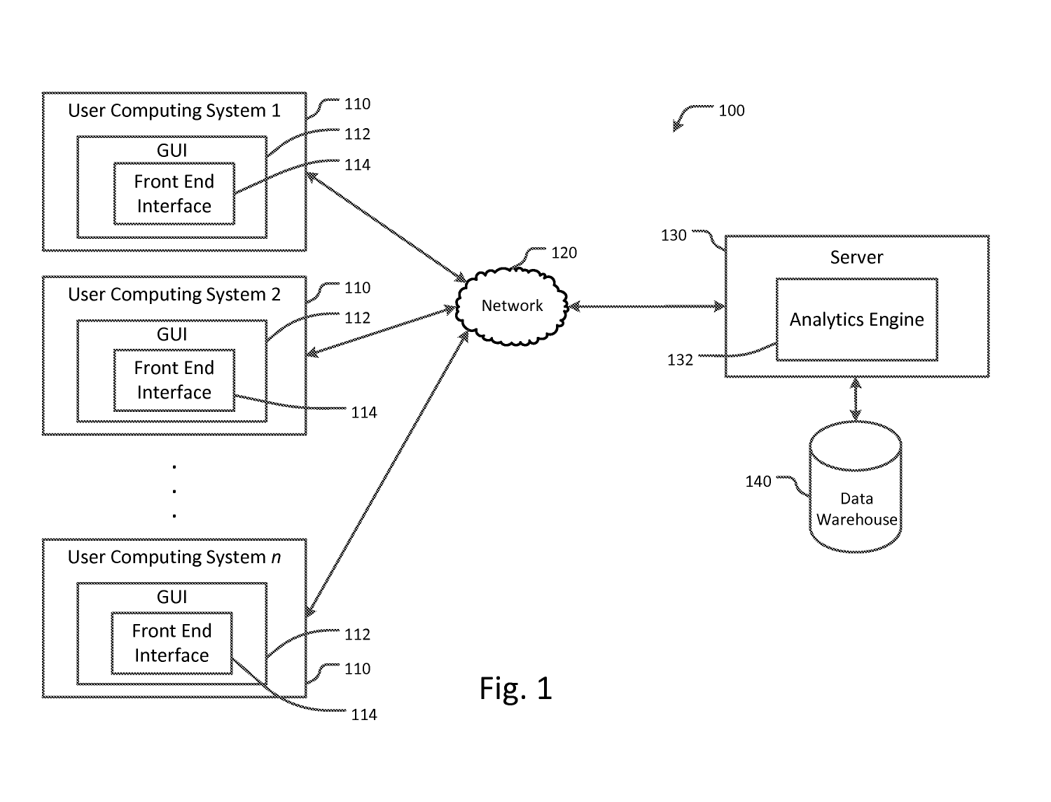

FIG. 1 illustrates an example client-server computing architecture 100 configured in accordance with an embodiment of the present invention. In this example, one or more user computing systems 110 each include a GUI 112 configured to provide a front end interface 114 and to interact electronically, via a communication network 120, with an analytics engine 132 hosted by a server 130. Although depicted in FIG. 1 as separate devices, it will be appreciated that in some embodiments the functionality of the user computing system 110 and the server 130 may be integrated into one computing environment; for example, the analytics engine 132 may be implemented locally on the user computing system 110. One or more data warehouses 140 operatively connected to the server 130 and the analytics engine 132 can be configured to store analytical data regarding the activities and interactions of one or more users with a website, and/or other data created and maintained by the analytics engine 132. The data warehouse 140 can be implemented, for example, with any suitable type of memory, such as a disk drive included in, or otherwise in communication with, the server 130. Other suitable memories include flash memory, random access memory (RAM), a memory stick or thumb drive, USB drive, cloud storage service, etc. In a more general sense, any memory facility can be used to implement the data warehouse 140.

As will be appreciated in light of this disclosure, the various modules and components shown in FIG. 1, such as the GUI 112, analytics engine 132 and data warehouse 140, can be implemented in software, such as a set of instructions (e.g., R and Revolution R programming languages, C, C++, object-oriented C, JavaScript, Java, BASIC, etc.) encoded on any computer readable medium or computer program product (e.g., hard drive, server, disc, or other suitable non-transient memory or set of memories), that when executed by one or more processors, cause the various methodologies provided herein to be carried out. It will be appreciated that, in some embodiments, various functions performed by the user computing system 110, the server 130, and data warehouse 140, as described herein, can be performed by similar processors and/or databases in different configurations and arrangements, and that the depicted embodiments are not intended to be limiting. Various components of this example embodiment, including the user computing systems 110 and/or server 130, can be integrated into, for example, one or more desktop or laptop computers, workstations, tablets, smartphones, game consoles, set-top boxes, or other such computing devices. Other componentry and modules typical of a computing system, such as processors (e.g., central processing unit and co-processor, graphics processor, etc.), input devices (e.g., keyboard, mouse, touch pad, touch screen, etc.), and operating system, are not shown but will be readily apparent. The network 120 can be any communications network, such as a user's local area network and/or the Internet, or any other public and/or private communication network (e.g., local and/or wide area network of a company, etc.). The GUI can be implemented using any number of known or proprietary browsers or comparable technology that facilitates retrieving, presenting, and traversing information resources, such as analytics information provided by the analytics engine 132 and/or web pages on a website, via a network, such as the Internet.

Example Computing Device

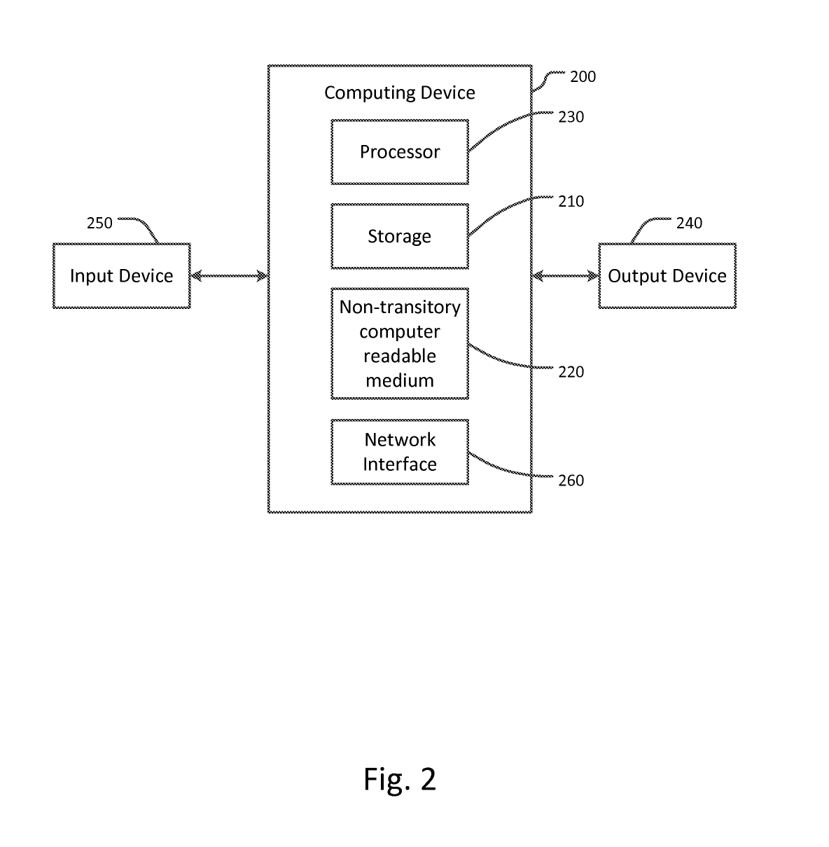

FIG. 2 is a block diagram representing an example computing device 200 that may be used to perform any of the techniques as variously described herein. The computing device 200 may be any computer system, such as a workstation, desktop computer, server, laptop, handheld computer, tablet computer (e.g., the iPad® tablet computer), mobile computing or communication device (e.g., the iPhone® mobile communication device, the Android™ mobile communication device, and the like), or other form of computing or telecommunications device that is capable of communication and that has sufficient processor power and memory capacity to perform the operations described herein. A distributed computational system may be provided comprising a plurality of such computing devices.

The computing device 200 includes one or more storage devices 210 and/or non-transitory computer-readable media 220 having encoded thereon one or more computer-executable instructions or software for implementing techniques as variously described herein. The storage device 210 may include a computer system memory or random access memory, such as a durable disk storage (which may include any suitable optical or magnetic durable storage device, e.g., RAM, ROM, Flash, USB drive, or other semiconductor-based storage medium), a hard-drive, CD-ROM, or other computer readable media, for storing data and computer-readable instructions and/or software that implement various embodiments as taught herein. The storage device 210 may include other types of memory as well, or combinations thereof. The storage device 210 may be provided on the computing device 200 or provided separately or remotely from the computing device 200. The non-transitory computer-readable media 220 may include, but are not limited to, one or more types of hardware memory, non-transitory tangible media (for example, one or more magnetic storage disks, one or more optical disks, one or more USB flash drives), and the like. The non-transitory computer-readable media 220 included in the computing device 200 may store computer-readable and computer-executable instructions or software for implementing various embodiments. The computer-readable media 220 may be provided on the computing device 200 or provided separately or remotely from the computing device 200.

The computing device 200 also includes at least one processor 230 for executing computer-readable and computer-executable instructions or software stored in the storage device 210 and/or non-transitory computer-readable media 220 and other programs for controlling system hardware. Virtualization may be employed in the computing device 200 so that infrastructure and resources in the computing device 200 may be shared dynamically. For example, a virtual machine may be provided to handle a process running on multiple processors so that the process appears to be using only one computing resource rather than multiple computing resources. Multiple virtual machines may also be used with one processor.

A user may interact with the computing device 200 through an output device 240, such as a screen or monitor, which may display one or more user interfaces provided in accordance with some embodiments. The output device 240 may also display other aspects, elements and/or information or data associated with some embodiments. The computing device 200 may include other input and/or output (I/O) devices 250 for receiving input from a user, for example, a keyboard or any suitable multi-point touch interface, a pointing device (e.g., a mouse, a user's finger interfacing directly with a display device, etc.). The computing device 200 may include other suitable conventional I/O peripherals.

The computing device 200 may include a network interface 260 configured to interface with one or more networks, for example, a Local Area Network (LAN), a Wide Area Network (WAN) or the Internet, through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 260 may include a built-in network adapter, network interface card, PCMCIA network card, card bus network adapter, wireless network adapter, USB network adapter, modem or any other device suitable for interfacing the computing device to any type of network capable of communication and performing the operations described herein. The network device 260 may include one or more suitable devices for receiving and transmitting communications over the network including, but not limited to, one or more receivers, one or more transmitters, one or more transceivers, one or more antennas, and the like.

The computing device 200 may run any operating system, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device 200 and performing the operations described herein. In an embodiment, the operating system may be run on one or more cloud machine instances.

In other embodiments, the functional components/modules may be implemented with hardware, such as gate level logic (e.g., FPGA) or a purpose-built semiconductor (e.g., ASIC). Still other embodiments may be implemented with a microcontroller having a number of input/output ports for receiving and outputting data, and a number of embedded routines for carrying out the functionality described herein. In a more general sense, any suitable combination of hardware, software, and firmware can be used, as will be apparent.

Example Methodologies

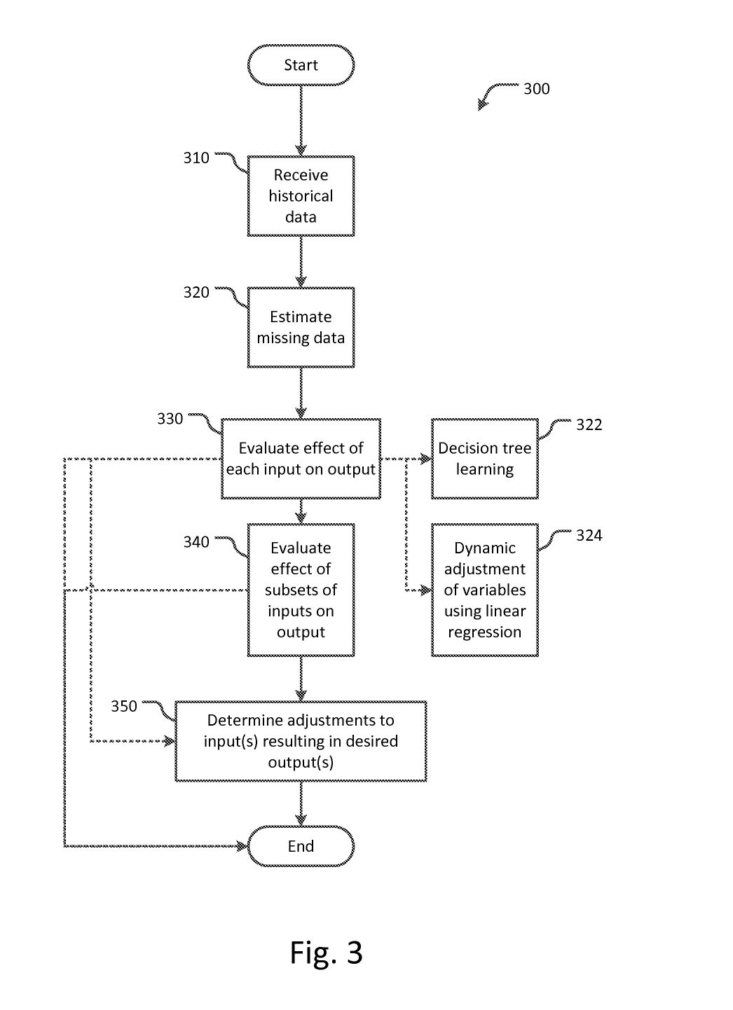

FIG. 3 illustrates an overview of an example methodology 300 for predicting outcomes of a system modeled on analytical data by dynamically adjusting one or more input or output variables that may be used in conjunction with various embodiments. In some embodiments, the methodology 300 may be implemented, for example, by the analytics engine of FIG. 1. Initially, at block 310, analytical data is received by a computing device, such as the server of FIG. 1. The analytical data can include any set or sets of values that represent measured quantities, such as website metrics. An example of such analytical data is shown in Table 1:

TABLE 1
Analytical Data Example (Incomplete)

| | | | | Av. No. | Av. No. | Av. No. |
|---|---|---|---|---|---|---|
| Av. | Av. No. | Av. Visit | Av. No. | Unique | Items | Unique |
| Revenue | Visits | Length | Orders | Visits | Ordered | Orders |
| 11.44 | | | | 7.24 | | |
| 87.9 | | | | | | |
| | | | | 3.83 | | |
| | | 76.8 | | | 111.44 | 1.3 |
| 71.99 | | | | | | 11.2 |
| | 111.2 | | 23.45 | | 187.9 | 2.9 |
| | | 222.76 | 48.75 | | | 3.9 |
| | 48.75 | | 42.9 | | | |
| | 42.9 | | 44.98 | | 171.99 | |
| | 44.98 | | | | | |
| | 87.7 | | | 5.34 | | |
| | 132.99 | | | | | |
| 23.98 | | | | | | |
| 43.67 | | | | | | |
| | 39.99 | | | | | |
| 65.34 | | | | | | |
| | 26.99 | | | | | |

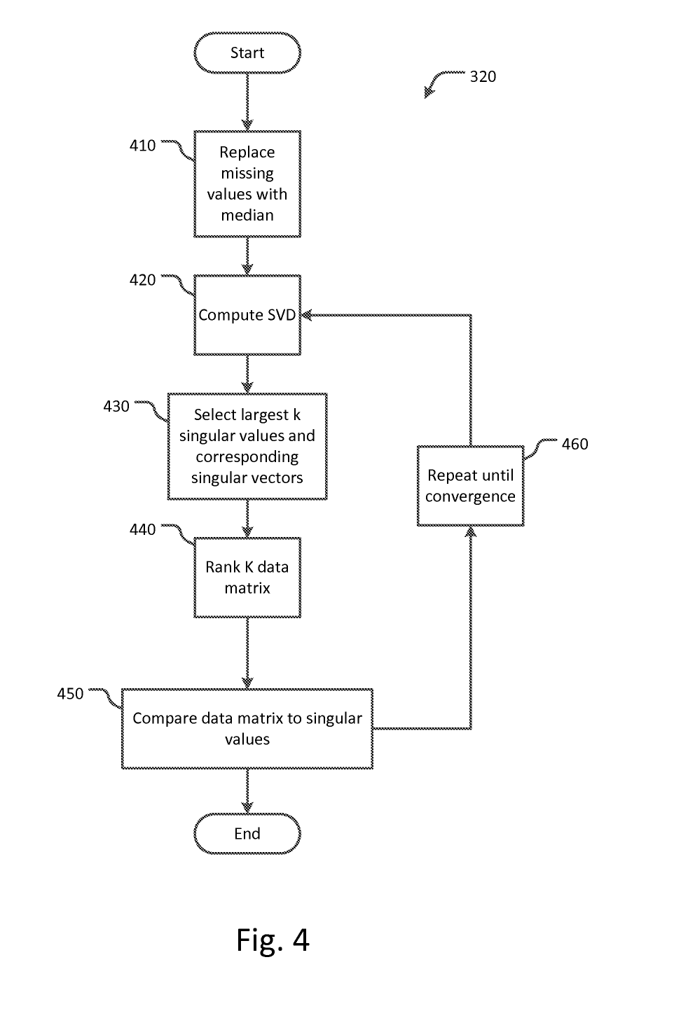

Each row of the data set includes data representing the activities of a different user (e.g., a customer visiting the website over the course of a year), and each column of the data set represents a different feature, attribute or variable for the respective user. As can be seen in Table 1, some data entries are missing, making the data set incomplete. At block 320, the missing data entries can be estimated to complete the data set. A regularized singular value decomposition (RSVD) technique can be used to estimate the missing entries according to the following example methodology, as shown in FIG. 4 in accordance with an example embodiment. As can be seen, this methodology is iterative in nature in that the loop including steps (b) to (f) repeats until convergence is achieved.

Step (a) 410: each missing data entry can be represented by a median of all known values for the respective variable. This produces a matrix, similar to the values shown in Table 1, having values for all data points.

Step (b) 420: the singular value decomposition (SVD) of the matrix is computed.

Step (c) 430: using the criteria of 90% of variation (or other suitable variation), the largest k singular values and the corresponding singular vectors are selected from the results of the SVD.

Step (d) 440: using constraint reconstruction error, a rank K data matrix X(k) is computed from the results of the SVD.

Step (e) 450: the values corresponding to the missing data in X(k), which are computed in step (d), are compared to the values obtained from the previous iteration of steps (b) through (f). For the first iteration of step (e), when there is no previous iteration of steps (b) through (f), the values computed at step (d) are compared to the initial valued from step (a). In this initial step (a), the missing initial values can be replaced, for example, with the median of their corresponding columns.

Step (f) 460: steps (b)-(e) are repeated until the computed values for the missing entries converge. Table 2 shows another example of analytical data where the missing entries of Table 1 are replaced with results acquired by performing the above-described estimation function 320.

Note that the use of the term “step” herein is for purposes of facilitating explanation of an example embodiment and is not intended to implicate any particular functional sequence or underlying structure. Rather, one or more of these so-called steps or variations thereof may be performed in any number of different sequences without departing from the scope of the disclosed embodiments. In some embodiments, certain steps may be omitted (e.g., steps (e) and/or (f)).

TABLE 2
Analytical Data Example (Complete)

| | | | | Av. No. | Av. No. | Av. No. |
|---|---|---|---|---|---|---|
| Av. | Av. No. | Av. Visit | Av. No. | Unique | Items | Unique |
| Revenue | Visits | Length | Orders | Visits | Ordered | Orders |
| 11.44 | 43.8816 | 124.039 | 22.8202 | 7.24 | 109.607 | 4.20724 |
| 91.8928 | 43.8684 | 121.257 | 38.9099 | 4.39241 | 107.569 | 5.09628 |
| 87.9 | 43.8573 | 121.372 | 38.111 | 4.43154 | 107.645 | 5.05158 |
| 91.9123 | 43.8071 | 121.13 | 38.8934 | 3.83 | 107.439 | 5.09229 |
| 93.9331 | 68.1814 | 76.8 | 31.1764 | 3.80402 | 111.44 | 1.3 |
| 71.99 | 43.5684 | 123.472 | 35.217 | 4.63019 | 108.518 | 11.2 |
| 75.7827 | 111.2 | 115.643 | 23.45 | 6.78864 | 187.9 | 2.9 |
| 78.6452 | 15.2664 | 222.76 | 48.75 | 6.66315 | 127.499 | 3.9 |
| 95.1082 | 48.75 | 123.904 | 42.9 | 4.58646 | 113.422 | 5.23391 |
| 97.3393 | 42.9 | 198.773 | 44.98 | 7.15774 | 171.99 | 7.64867 |
| 91.9339 | 44.98 | 120.906 | 38.8427 | 4.40516 | 108.165 | 5.08828 |
| 88.9634 | 87.7 | 107.229 | 34.9665 | 5.34 | 147.088 | 4.77317 |
| 85.804 | 132.99 | 92.6754 | 30.8457 | 6.51507 | 188.33 | 4.43729 |
| 23.98 | 43.6914 | 123.217 | 25.2692 | 5.06073 | 108.891 | 4.33314 |
| 43.67 | 43.7425 | 122.649 | 29.225 | 4.86692 | 108.508 | 4.55445 |
| 92.2815 | 39.99 | 122.507 | 39.2961 | 4.28553 | 103.62 | 5.12519 |
| 65.34 | 43.7988 | 122.023 | 33.5786 | 4.65361 | 108.085 | 4.79802 |
| 93.1869 | 26.99 | 126.676 | 40.4773 | 3.97388 | 91.7783 | 5.22135 |

In Table 2, each column represents a variable. Any variable can be designated as an output variable, and the remaining columns in Table 2 represent input variables. In other words, the output variable can be treated as a function of one or more of the input variables. Assuming several variables in Table 2 are interdependent (i.e., at least some variables are not independent of all other variables) then a change in one or more input variables may affect a change in the output variable. For example, the Average Revenue variable (e.g., the first column in Table 2) may be arbitrarily designated as the output variable. Accordingly, all the other variables (e.g., the other columns in Table 2) are input variables.

Referring again to FIG. 3, subsequent to estimating the missing data 320, at block 330 a quantifiable effect of one of the input variables on the output variable can be evaluated relative to at least one of the other input variables based on the analytical data. For instance, it may be desirable to determine which input variable(s) in Table 2, when changed, have the greatest effect on changing the designated output variable. According to an embodiment, there are two techniques for determining the effect of the input variables on the output variable. One technique includes using decision tree learning (block 322), and the other technique includes using linear regression (block 324). Both techniques 322, 324 may be used independently, and the results of, for example, the linear regression technique 324 may be used to validate the results of the decision tree learning technique 322. In some embodiments, the decision tree learning technique 322, the linear regression technique 324, or both techniques, can be employed.

The first technique for determining the effect of input variables on an output variable includes applying decision tree learning 322 to the analytical data. In an example implementation, the effect of a given input variable on one or more output variables can be computed by selecting 1,000 decision trees (e.g., using a Random Forests® framework) and measuring the increase in the error (e.g., mean squared error (MSE)) of the output variables when the given input variable is perturbed. Higher errors indicate greater effect. Table 3 shows a representative example of the results of this technique, as applied to the example analytical data in Table 2, where the output variable is Average Revenue.

TABLE 3
Decision Tree Learning Analysis Example Results

| | Increase in |
|---|---|
| Input | MSE (%) |
| Av. No. Visits | 4.5548499 |
| Av. Visit Length | 8.4237906 |
| Av. No. Orders | 17.8467325 |
| Av. No. Unique Visits | 11.5073140 |
| Av. No. Items Ordered | 5.7151598 |
| Av. No. Unique Orders | 7.7498218 |

The example results shown in Table 3 indicate that the inputs having the greatest effect on Average Revenue are Average Number of Orders (˜17.8%) and Average Number of Unique Visits (˜11.5%). In other words, changes to the average number of orders per user visit to the website and changes to the average number of unique visits per user to the website affect the average revenue per website user more significantly than any other variable in the analytical data. These results can be displayed to a user via, for example, a graphical user interface (e.g., the front end interface via the GUI of FIG. 1) or other suitable output device, in a human readable form. The human readable form may include, for example, charts, tables, graphs or other suitable formats as will be apparent.

The second technique for determining the effect of input variables on an output variable includes using dynamic adjustment of the input variables using linear regression 324. In an example implementation, consider the following multiple linear regression equation:

y=a(0)+a(1)X(1)+a(2)X(2)+ . . . +a(n)X(n) (1)

where y is an output variable, X(1) . . . X(n) are input variables and a(0) . . . a(n) are the coefficients of the regression equation. When the analytical data is modeled using regression analysis, the magnitude of the coefficients a(1) . . . a(n) each represent the relative effect of the corresponding input variable on the output variable. In this example, presume that y represents Average Revenue and each X represents a different variable in the analytical data. It will be understood that any variable in the analytical data can be considered the output and that any of the remaining variables can be considered inputs. Table 4 shows a representative example of the results of this technique, as applied to the example analytical data in Table 2, where the output variable y is Average Revenue.

TABLE 4
Regression Analysis Example Results

| | | Estimated | | |
|---|---|---|---|---|
| | | Std. | | |
| Input | Coefficients | Error | t value | pr(>\|t\|) |
| (Intercept) | 14.4714 | 16.4212 | 0.881 | 0.38319 |
| Av. No. | −0.3865 | 0.5523 | −0.700 | 0.48797 |
| Visits | | | | |
| Av. Visit | −0.6006 | 0.3363 | −1.786 | 0.08139 |
| Length | | | | |
| Av. No. | 3.4186 | 0.3207 | 10.661 | 1.60E−13 |
| Orders | | | | |
| Av. No. | −14.7141 | 5.0934 | −2.889 | 0.00609 |
| Unique Visits | | | | |
| Av. No. | 0.9210 | 0.4744 | 1.941 | 0.05893 |
| Items Ordered | | | | |
| Av. No. | −0.1277 | 1.8062 | −0.071 | 0.94397 |
| Unique Orders | | | | |

Here, the regression analysis verifies the results of the decision tree learning analysis in indicating that the inputs having the greatest effect on Average Revenue are Average Number of Orders (a=3.4186) and Average Number of Unique Visits (a=−14.7141), since the absolute value of the magnitude of the coefficients corresponding to these two variables is greater than the coefficients corresponding to any other variable in the analytical data (the regression analysis is based on scaled data). Also, their very low corresponding p-value, pr(>|t|), indicates their high significance. These results can be displayed to a user via, for example, a graphical user interface or other suitable output device, in a human readable form. The human readable form may include, for example, charts, tables, graphs or other suitable formats as will be apparent.

Referring again to FIG. 3, subsequent to evaluating the effect of one or more inputs on the output 330, at block 340 the effect of subsets of input variables (e.g., groups of one or more input variables) on the output variable can be evaluated. That is, the magnitude of change to a given output variable caused by a predicted adjustment of one or more input variables can be evaluated by applying the analytical data to Equation (1). For example, as shown in Table 5, if the Number of Orders (an input) is predicted to increase by 20%, the corresponding variable may be increased accordingly by multiplying it by 1.2. In this example, the other input variables are held constant, although it will be understood that more than one input variable may be changed to evaluate the effect of the combined changes on the output variable.

TABLE 5
Regression Analysis Example Parameters

| Input | Coefficients | Adjusted |
|---|---|---|
| (Intercept) | 14.4714 | Constant |
| Av. No. Visits | −0.3865 | Constant |
| Av. Visit Length | −0.6006 | Constant |
| Av. No. Orders | 3.4186 | *1.2 |
| Av. No. Unique Visits | −14.7141 | Constant |
| Av. No. Items Ordered | 0.9210 | Constant |
| Av. No. Unique Orders | −0.1277 | Constant |

Applying Equation (1) for a data point of X={80, 12, 45, 11, 2, 56, 3}, the Average Revenue variable increases by 9.4% (where all other input variables are fixed). It will be understood that any input or multiple inputs can be so adjusted to compute the output using Equation (1) or a similar regression formula. These results can be displayed to a user via, for example, a graphical user interface or other suitable output device, in a human readable form. The human readable form may include, for example, charts, tables, graphs or other suitable formats as will be apparent.

Referring again to FIG. 3, subsequent to evaluating the effect of subsets of input variables on an output variable 340, at block 350 determinant adjustments to one or more input variables to affect a desired change in the output variable can be computed. For example, it may be desirable to increase the Average Revenue output variable by 20% by adjusting only the Average Number of Unique Visits input variable. Using Equation (1), the Average Number of Unique Visits variable can be regressed with respect to the remaining variables. Table 6 shows a representative example of the results of this technique, as applied to the example analytical data in Table 2, where the output variable y is Average Revenue and the adjusted input variable (e.g., X(4)) is Average Number of Unique Visits. In this example, for the purpose of the regression analysis, “Average Revenue” becomes one of the input variables and “Average Number of Unique Visits” is the output variable.

TABLE 6
Regression Analysis Example Results

| | | Estimated | | |
|---|---|---|---|---|
| Input | Coefficients | Std. Errort | value | pr(>\|t\|) |
| (Intercept) | 0.243604 | 0.457015 | 0.533 | 0.59682 |
| Average | −0.011266 | 0.003900 | −2.889 | 0.00609 |
| Revenue | | | | |
| Av. No. | 0.0118 | 0.015263 | 0.773 | 0.44384 |
| Visits | | | | |
| Av. Visit | 0.0196 | 0.009166 | 2.142 | 0.03801 |
| Length | | | | |
| Av. No. | 0.0038 | 0.017071 | 0.225 | 0.82322 |
| Orders | | | | |
| Av. No. | 0.0199 | 0.013356 | 1.488 | 0.14433 |
| Items Ordered | | | | |
| Av. No. | −0.0036 | 0.049977 | −0.073 | 0.94247 |
| Unique Orders | | | | |

Solving Equation (1) using the example analytical data of Table 2 shows that to increase the output (Average Revenue) by 20%, the input (Average Number of Unique Visits) must be decreased by 8%. It will be understood that the needed adjustment of any input or multiple inputs can be computed to achieve the desired change in output using Equation (1) or a similar regression formula. These results can be displayed to a user via, for example, a graphical user interface or other suitable output device, in a human readable form. The human readable form may include, for example, charts, tables, graphs or other suitable formats as will be apparent. Here, for the purpose of the regression analysis, “Average Revenue” becomes one of the input variables and “Average Number of Unique Visits” is the output variable, as will be appreciated.

It will be understood that, in some embodiments, the order and sequence of functions described with respect to FIG. 3 can be changed. For instance, in one embodiment, the adjustments to one or more input variables that result in a desired output 350 can be determined prior to evaluating the effect of subsets of input variables on an output variable 340 and/or evaluating the effect of each input on the output 330. In another embodiment, the effect of subsets of input variables on an output variable 340 can be evaluated prior to evaluating the effect of each input on the output 330. In yet another embodiment, one or more of the functions indicated at 330, 332, 324, 340 and 350 in FIG. 3 are not necessarily performed, depending on various factors such as user input. Other configurations will be apparent in light of this disclosure.

Numerous embodiments will be apparent in light of the present disclosure, and features described herein can be combined in any number of configurations. One example embodiment of the invention provides a computer-implemented method. The method includes receiving, from a database in electronic communication with a processor, analytical data representing a plurality of website metric variables; designating one of the variables as an output variable and each of the remaining variables as input variables; computing, by the processor, first result data representing a quantifiable effect of one of the input variables on the output variable relative to at least one of the other input variables based on the analytical data; and presenting, via a graphical user interface, the first result data in human readable form. In some cases, the method includes computing, by the processor, second result data representing a magnitude of change of the output variable caused by a predicted adjustment of the one or more input variables using linear regression; and presenting, via the graphical user interface, the second result data in human readable form. In some cases, the method includes computing, by the processor, third result data representing a determinant adjustment of the one or more input variables needed to affect a desired change in the output variable using linear regression; and presenting, via the graphical user interface, the third result data in human readable form. In some cases, the analytical data includes at least one missing value, and the method includes computing the missing value(s) based on non-missing values in the analytical data using a regularized singular value decomposition. In some cases, computing the first result data includes computing a magnitude of increase in an error of the output variable resulting from a perturbation of each of the input variables using decision tree learning. In some other cases, computing the first result data includes computing a magnitude of increase in an error of the output variable resulting from a perturbation of each of the input variables using linear regression. In some cases, the human readable form includes at least one of a chart, table and graph. In some cases, some or all of the functions variously described in this paragraph can be performed in any order and at any time by one or more different processors.

Another example embodiment provides a system including a storage, a display configured to provide a graphical user interface, and one or more processors operatively coupled to the storage and the display. The one or more processors are configured to execute instructions stored in the storage that when executed cause the processor(s) to carry out a process including receiving, from a database in electronic communication with the processor, analytical data representing a plurality of website metric variables; designating one of the variables as an output variable and each of the remaining variables as input variables; computing first result data representing a quantifiable effect of one of the input variables on the output variable relative to at least one of the other input variables based on the analytical data; and presenting, via the graphical user interface, the first result data in human readable form. In some cases, the process includes computing second result data representing a magnitude of change of the output variable caused by a predicted adjustment of the one or more input variables using linear regression; and displaying, via the graphical user interface, the second result data in human readable form. In some cases, the process includes computing third result data representing a determinant adjustment of the one or more input variables needed to affect a desired change in the output variable using linear regression; and presenting, via the graphical user interface, the third result data in human readable form. In some cases, the analytical data includes at least one missing value, and the process includes computing the missing value(s) based on non-missing values in the analytical data using a regularized singular value decomposition. In some cases, computing the first result data includes computing a magnitude of increase in an error of the output variable resulting from a perturbation of each of the input variables using decision tree learning. In some cases, computing the first result data includes computing a magnitude of increase in an error of the output variable resulting from a perturbation of each of the input variables using linear regression. In some cases, the human readable form includes at least one of a chart, table and graph. Another embodiment provides a non-transient computer-readable medium or computer program product having instructions encoded thereon that when executed by one or more processors cause the processor to perform one or more of the functions defined in the present disclosure, such as the methodologies variously described in this paragraph. As previously discussed, in some cases, some or all of the functions variously described in this paragraph can be performed in any order and at any time by one or more different processors.

Yet another example embodiment provides a computer-implemented method. The method includes receiving, from a database in electronic communication with a processor, analytical data representing a plurality of website metric variables; estimating at least one missing value in the analytical data based on non-missing values in the analytical data using a regularized singular value decomposition; designating one of the variables as an output variable and each of the remaining variables as input variables; evaluating, by the processor, a quantifiable effect of one of the input variables on the output variable relative to at least one of the other input variables based on the analytical data; evaluating, by the processor, a magnitude of change of the output variable caused by a predicted adjustment of the one or more input variables using linear regression; and determining, by the processor, a determinant adjustment of the one or more input variables needed to affect a desired change in the output variable using linear regression. In some cases, evaluating the quantifiable effect of one of the input variables on the output variable includes computing a magnitude of increase in an error of the output variable resulting from a perturbation of each of the input variables using decision tree learning. In some other cases, evaluating the quantifiable effect of one of the input variables on the output variable includes computing a magnitude of increase in an error of the output variable resulting from a perturbation of each of the input variables using linear regression. In some cases, the regularized singular value decomposition includes replacing, by the processor, the at least one missing value with a median of the non-missing values to create a revised set of analytical data; computing, by the processor, a singular value decomposition of the revised set of analytical data; selecting, by the processor, the largest k singular values of the singular value decomposition and singular vectors corresponding to the largest k singular values to create a K data matrix; ranking, by the processor, the K data matrix; and comparing the revised set of analytical data to the K data matrix. In some such cases, the method includes repeating the acts of computing the singular value decomposition, selecting the largest k singular values, ranking the K data matrix and comparing the revised set of analytical data to the K data matrix are repeated until the comparison yields a convergence of values. In some cases, the method includes presenting, via a graphical user interface, at least one of the quantifiable effect of one of the input variables on the output variable, the magnitude of change of the output variable caused by a predicted adjustment of the one or more input variables, and the determinant adjustment of the one or more input variables needed to affect a desired change in the output variable in human readable form. Another embodiment provides a non-transient computer-readable medium or computer program product having instructions encoded thereon that when executed by one or more processors cause the processor to perform one or more of the functions defined in the present disclosure, such as the methodologies variously described in this paragraph. As previously discussed, in some cases, some or all of the functions variously described in this paragraph can be performed in any order and at any time by one or more different processors. In some embodiments, one or more of the functions variously described in this paragraph may be performed optionally, such as in response to a user input. For example, the functions of evaluating the quantifiable effect of one of the input variables on the output variable relative to at least one of the other input variables, evaluating the magnitude of change of the output variable caused by a predicted adjustment of the one or more input variables, and determining the determinant adjustment of the one or more input variables needed to affect a desired change in the output variable using linear regression may be performed in any sequence and independently of each other, depending on which function or functions the user selects for processing.

The foregoing description and drawings of various embodiments are presented by way of example only. These examples are not intended to be exhaustive or to limit the invention to the precise forms disclosed. Numerous variations will be apparent in light of this disclosure. Alterations, modifications, and variations will readily occur to those skilled in the art and are intended to be within the scope of the invention as set forth in the claims.

What is claimed is:

1. A computer-implemented method comprising:
receiving, from a database in electronic communication with a processor, analytical data representing a plurality of website metric variables;
designating one of the variables as an output variable and each of the remaining variables as input variables;
computing, by the processor, first result data representing a quantifiable effect of one of the input variables on the output variable relative to at least one of the other input variables based on the analytical data; and
presenting, via a graphical user interface, the first result data in human readable form.

2. The method of claim 1, further comprising:
computing, by the processor, second result data representing a magnitude of change of the output variable caused by a predicted adjustment of the one or more input variables using linear regression; and
presenting, via the graphical user interface, the second result data in human readable form.

3. The method of claim 1, further comprising:
computing, by the processor, third result data representing a determinant adjustment of the one or more input variables needed to affect a desired change in the output variable using linear regression; and
presenting, via the graphical user interface, the third result data in human readable form.

4. The method of claim 1, wherein the analytical data includes at least one missing value, and wherein the method further comprises computing the at least one missing value based on non-missing values in the analytical data using a regularized singular value decomposition.

5. The method of claim 1, wherein computing the first result data includes computing a magnitude of increase in an error of the output variable resulting from a perturbation of each of the input variables using decision tree learning.

6. The method of claim 1, wherein computing the first result data includes computing a magnitude of increase in an error of the output variable resulting from a perturbation of each of the input variables using linear regression.

7. The method of claim 1, wherein the human readable form includes at least one of a chart, table and graph.

8. A system comprising:
a storage;
a display configured to provide a graphical user interface; and
a processor operatively coupled to the storage and the display, the processor configured to execute instructions stored in the storage that when executed cause the processor to carry out a process comprising:
receiving, from a database in electronic communication with the processor, analytical data representing a plurality of website metric variables;
designating one of the variables as an output variable and each of the remaining variables as input variables;
computing first result data representing a quantifiable effect of one of the input variables on the output variable relative to at least one of the other input variables based on the analytical data; and
presenting, via the graphical user interface, the first result data in human readable form.

9. The system of claim 8, wherein the process further comprises:
computing second result data representing a magnitude of change of the output variable caused by a predicted adjustment of the one or more input variables using linear regression; and
displaying, via the graphical user interface, the second result data in human readable form.

10. The system of claim 8, wherein the process further comprises:
computing third result data representing a determinant adjustment of the one or more input variables needed to affect a desired change in the output variable using linear regression; and
presenting, via the graphical user interface, the third result data in human readable form.

11. The system of claim 8, wherein the analytical data includes at least one missing value, and wherein the process further comprises computing the at least one missing value based on non-missing values in the analytical data using a regularized singular value decomposition.

12. The system of claim 8, wherein computing the first result data includes computing a magnitude of increase in an error of the output variable resulting from a perturbation of each of the input variables using decision tree learning.

13. The system of claim 8, wherein computing the first result data includes computing a magnitude of increase in an error of the output variable resulting from a perturbation of each of the input variables using linear regression.

14. The system of claim 8, wherein the human readable form includes at least one of a chart, table and graph.

15. A computer-implemented method comprising:
receiving, from a database in electronic communication with a processor, analytical data representing a plurality of website metric variables;
estimating at least one missing value in the analytical data based on non-missing values in the analytical data using a regularized singular value decomposition;
designating one of the variables as an output variable and each of the remaining variables as input variables;
evaluating, by the processor, a quantifiable effect of one of the input variables on the output variable relative to at least one of the other input variables based on the analytical data;
evaluating, by the processor, a magnitude of change of the output variable caused by a predicted adjustment of the one or more input variables using linear regression; and
determining, by the processor, a determinant adjustment of the one or more input variables needed to affect a desired change in the output variable using linear regression.

16. The method of claim 15, wherein evaluating the quantifiable effect of one of the input variables on the output variable includes computing a magnitude of increase in an error of the output variable resulting from a perturbation of each of the input variables using decision tree learning.

17. The method of claim 15, wherein evaluating the quantifiable effect of one of the input variables on the output variable includes computing a magnitude of increase in an error of the output variable resulting from a perturbation of each of the input variables using linear regression.

18. The method of claim 15, wherein the regularized singular value decomposition comprises:
replacing, by the processor, the at least one missing value with a median of the non-missing values to create a revised set of analytical data;
computing, by the processor, a singular value decomposition of the revised set of analytical data;
selecting, by the processor, the largest k singular values of the singular value decomposition and singular vectors corresponding to the largest k singular values to create a K data matrix;
ranking, by the processor, the K data matrix; and
comparing the revised set of analytical data to the K data matrix.

19. The method of claim 18, further comprising repeating the acts of computing the singular value decomposition, selecting the largest k singular values, ranking the K data matrix and comparing the revised set of analytical data to the K data matrix are repeated until the comparison yields a convergence of values.

20. The method of claim 15, further comprising presenting, via a graphical user interface, at least one of the quantifiable effect of one of the input variables on the output variable, the magnitude of change of the output variable caused by a predicted adjustment of the one or more input variables, and the determinant adjustment of the one or more input variables needed to affect a desired change in the output variable in human readable form.
